(19) United States
(12) Patent Application Publication
(10) Pub. No.: US 2025/0176721 A1
(43) Pub. Date: Jun. 5, 2025

(54) GET-UP ASSISTANCE DEVICE, GET-UP ASSISTANCE METHOD, AND STORAGE MEDIUM

(71) Applicant: TOYOTA BOSHOKU KABUSHIKI KAISHA, Aichi (JP)

(72) Inventor: Tatsuo KAWAI, Aichi (JP)

(73) Assignee: TOYOTA BOSHOKU KABUSHIKI KAISHA, Aichi (JP)

(21) Appl. No.: 18/917,344

(22) Filed: Oct. 16, 2024

(30) Foreign Application Priority Data
Dec. 1, 2023 (JP) 2023-204154

(51) Int. Cl. A47C 3/20; A47C 7/56

(52) U.S. Cl. CPC A47C 3/20; A47C 7/56

(57) ABSTRACT

A get-up assistance device controls a position of a user by driving a driving mechanism so that a load level on a circulatory system based on a height difference between a center of gravity of a whole body of a user and a heart of the user becomes not less than a predetermined value with a load level on the circulatory system in a standing position as a reference.

This Nonprovisional application claims priority under 35 U.S.C. § 119 on Patent Application No. 2023-204154 filed in Japan on Dec. 1, 2023, the entire contents of which are hereby incorporated by reference.

### TECHNICAL FIELD

The present disclosure relates to a get-up assistance device, a get-up assistance method, and a storage medium.

### BACKGROUND ART

Conventionally, a bed device has been known in which a raising back operation is carried out on the basis of a position of a user which has been detected by a position detector in order to prompt a user to wake up (e.g. Patent Literature 1).

### CITATION LIST

### Patent Literature

### [Patent Literature 1]

Japanese Patent No. 7000247

### SUMMARY OF INVENTION

### Technical Problem

However, the invention disclosed in Patent Literature 1 does not consider a load on the body when getting up, and thus there is a risk that the device fails to allow for smoothly getting up.

It is an object of an aspect of the present disclosure to reduce a load on a body when getting up.

### Solution to Problem

In order to solve the foregoing problem, a get-up assistance device in accordance with an aspect of the present disclosure includes: a body section made up from a seat section configured to support a thigh of a user, an upper-body support section coupled to one end part of the seat section and configured to support an upper body of the user, and a lower-leg support section coupled to another end part of the seat section and configured to support a lower leg of the user; a driving mechanism capable of changing a position of the user, the driving mechanism being provided to the body section; and a controller configured to control the driving mechanism, the controller controlling the position of the user by driving the driving mechanism so that a load level on a circulatory system based on a height difference between a center of gravity of a whole body of the user and a heart of the user becomes not less than a predetermined value with the load level on the circulatory system in a standing position as a reference.

A get-up assistance method in accordance with an aspect of the present disclosure is a get-up assistance method used for a get-up assistance device including: a body section made up from a seat section configured to support a thigh of a user, an upper-body support section coupled to one end part of the seat section and configured to support an upper body of the user, and a lower-leg support section coupled to another end part of the seat section and configured to support a lower leg of the user; a driving mechanism capable of changing a position of the user, the driving mechanism being provided to the body section; and a controller configured to control the driving mechanism, the method including controlling the position of the user by driving the driving mechanism so that a load level on a circulatory system based on a height difference between a center of gravity of a whole body of the user and a heart of the user becomes not less than a predetermined value with the load level on the circulatory system in a standing position as a reference.

In order to solve the foregoing problem, a computer-readable storage medium in accordance with an aspect of the present disclosure is a computer-readable storage medium storing an estimation program that causes a computer to carry out: a process of calculating a center of gravity of each of segments of a body of a user; a process of calculating a center of gravity of a whole body of the user on the basis of the center of gravity of each of the segments; a process of calculating a height difference between the center of gravity of the whole body and a heart in a gravitational direction; and a process of estimating a load level on a circulatory system as a relative value with the height difference in a standing position as a reference on the basis of the height difference.

### Advantageous Effects of Invention

According to an aspect of the present disclosure, it is possible to reduce a load on a body when getting up.

### BRIEF DESCRIPTION OF DRAWINGS

FIG. 1 is a view schematically illustrating a configuration of an example of a get-up assistance device in accordance with an embodiment of the present disclosure.

FIG. 2 is a view for explaining a load level on a circulatory system based on a height difference between the center of gravity of a whole body and the heart.

FIG. 3 is a view illustrating an example of a position change in wakefulness induction.

FIG. 4 is a view for explaining a load level on a circulatory system in the position change illustrated in FIG. 3.

FIG. 5 is a view for explaining Comparative Examples and Examples.

FIG. 6 is a view illustrating an experimental result.

FIG. 7 is a view explaining a result of estimation of a load level on a circulatory system in a head-up tilt test.

### DESCRIPTION OF EMBODIMENTS

The following will describe a get-up assistance device 100 in accordance with an embodiment of the present disclosure with reference to the drawings in detail. The embodiments described below are examples of embodiments of the present disclosure, and the present disclosure shall not be construed as being limited to these embodiments. The drawings used in the following descriptions are schematically illustrated, and do not necessarily reflect the actual parts. For convenience of illustration and understanding, for example, the scale and the horizontal-to-vertical dimensional ratio may be altered from the actual parts and exaggerated. The same parts in the drawings are given the same reference numerals, and the descriptions thereof will be omitted.

### (Outline of Get-Up Assistance Device 100)

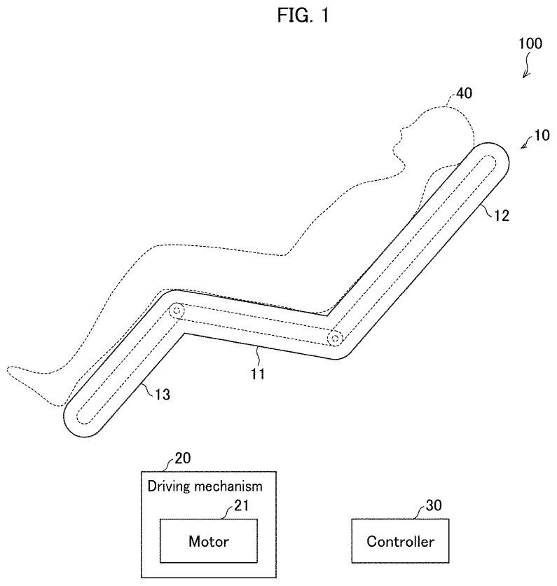

FIG. 1 is a view schematically illustrating a configuration of an example of a get-up assistance device 100. As illustrated in FIG. 1, the get-up assistance device 100 includes a body section 10, a driving mechanism 20, and a controller 30.

The body section 10, which is a section configured to support a user 40 in, for example, a seated state or a face-up state, is made up from a seat section 11, an upper-body support section 12, and a lower-leg support section 13.

The seat section 11, which is capable of supporting a thigh of the user 40 from below, slightly tilts so that a rear part of the seat section 11 is located in a lower position than a front part thereof when seen in a side view. The term “thigh” herein refers to a region from the hip joint to the knee joint.

The upper-body support section 12 is coupled to the rear end part of the seat section 11 so as to enable the upper-body support section 12 to move by rotation. The upper-body support section 12, which is configured to support the upper body of the user 40 from below, tilts so that the rear end part thereof is located in an upper position than the front end part thereof coupled to the seat section 11. Here, the term “upper body” refers to an upper part of a body, from the waist up. Note that the rear end part of the seat section 11 corresponds to “one end part”

The lower-leg support section 13 is coupled to the front end part of the seat section 11 so as to enable the lower-leg support section 13 to move by rotation. The lower-leg support section 13, which is configured to support the lower leg of the user 40 from below, tilts so that the front end part thereof is located in a lower position than the rear end part thereof coupled to the seat section 11. Here, the term “lower leg” refers to a region from the knee joint to the ankle. Note that the front end part of the seat section 11 corresponds to “another end part”.

Such a body section 10 may be used as a “bed”, or may be used as a “sofa”, or may be used as a “recliner chair”, or may be used as a “seat for a moving body”. Examples of the moving body include vehicles, aircraft, ships, railway vehicles, and spacecraft.

The body section 10 is configured to be deformable between a bed form and a chair form by the driving mechanism 20.

The driving mechanism 20 is described as a motor 21, but is not limited to the motor 21. The driving mechanism 20 may be a link mechanism, or may be a cylinder mechanism, or may be an air bag, or may be another mechanism that enables the body section 10 to move by rotation.

The controller 30 controls the position of the user 40 by, for example, driving the driving mechanism 20 in accordance with an operation by the user 40 or driving the driving mechanism 20 on the basis of the time schedule set in advance. Such a controller 30 may be a well-known remote controller or may be a control device fixed to the body section 10. Further, the controller 30 may be, for example, a smartphone, a tablet terminal, or a smartwatch, provided that it has a function of driving the driving mechanism 20.

Examples of a usage situation of the get-up assistance device 100 include a situation in which the upper body of the user 40 who is lying on the body section 10 and napping is raised to induct the user 40 to wake up so that the load applied on the body when getting up is reduced. It is needless to say that the usage situation is not limited to a nap and may be a usual sleep.

Typically, when the human wakes up from a nap (including a normal sleep) and gets up, the human changes his/her position from a supine position to a standing position. When the position is changed from a supine position to a standing position, the body activates the sympathetic nerve in order to prevent fainting which occurs due to reduced cerebral blood flow. This activation causes the blood vessels of the foot to shrink and increase the heart rate to increase an amount of the blood flow. At this time, the heart rate is generally increased by approximately 15 beats per minute. Here, orthostatic hypotension would delay the response of the circulatory system in some cases. This is a cause of orthostatic anemia or fainting. Therefore, for a person suffering from orthostatic hypotension, it is required, in wakefulness induction, to cause the person to get up while increasing the heart rate with reducing a load on the circulatory system in a transition from a supine position to a standing position. Considering the transition to a standing position, it is preferable to smoothly increase the heart rate to a level equivalent to that in a chair-seated position in the head-up tilt test.

### (Head-Up Tilt Test)

The head-up tilt test is a well-known test used for an autonomic function test. In the head-up tilt test, in a case of a healthy person, the person is caused to tilt from a supine position to a tilt angle of 60° to 80° which corresponds to a standing position in 30 seconds. It is known that at this time, if the tilt angle is 70°, the heart rate is increased by approximately 15 beats per minute. In a case where the presence of orthostatic hypotension is known in advance, the heart rate is measured at a tilt angle of 20° to 30° which corresponds to the chair-seated position. It is known that at this time, if the tilt angle is 30°, the heart rate is increased by approximately 5 to 8 beats per minute. The above statement “it is preferable to smoothly increase the heart rate to a level equivalent to that in a chair-seated position in the head-up tilt test” means that it is preferable to increase the heart rate by approximately 5 to 8 beats per minute. See “Thirutoteburu ni yoru taiihenkanji no junkann⋅jiritsushinkeikei no hendou (variation in circulatory/autonomic nervous system in change in body position using tilt table): Yuki Yamamoto, et.al, Manabigaoka ronsyu (Manabigaoka annals) 25: pp 49-59, 2016” as needed for details of the head-up tilt test.

The following description will describe a load on the circulatory system. Typically, a load on the circulatory system is determined in accordance with a height difference between the heart and the end part. Assuming that the height difference between the heart and the end part in a standing position is 100%, the height difference in a chair-seated position is approximately 50%. However, unlike the head-up tilt test carried out in an upright position, the evaluation using the height difference between the heart and the end part fails to consider the alignment of the segments of the body, that is, the so-called position. The inventors found that in the evaluation using the height difference between the heart and the end part, the load on the circulatory system may be underestimated. Therefore, the inventors focused on the height difference between the center of gravity of the whole body and the heart as an index for evaluating the load on the circulatory system rather than the height difference between the heart and the end part, and devised a method for estimating a load level on the circulatory system based on the height difference between the center of gravity of the whole body and the heart. The inventors thus decided to use the load level on the circulatory system based on the height difference between the center of gravity of the whole body and the heart as an evaluation index.

### (Method for Estimating Load Level on Circulatory System Based on Height Difference Between Center of Gravity of Whole Body and Heart)

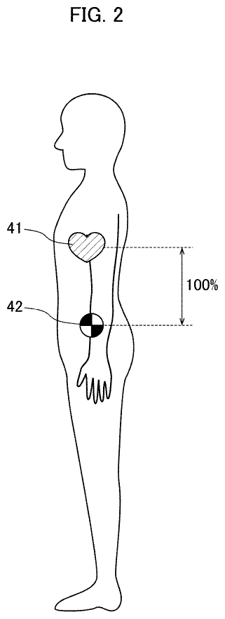

With reference to FIG. 2, the following will describe a method for estimating a load level on the circulatory system based on the height difference between the center of gravity of a whole body and the heart.

The following assumes that the densities of the segments of the body are uniform and the load on the circulatory system follows the Bernoulli's principle. The center of gravity 42 of the whole body representing the sum of the positional energies is obtained from the lengths, the masses, and the center-of-gravity positions of the following segments: a head (including neck), a trunk, upper arms, forearms and hands, a thigh, and a lower leg and foot, into which the whole body is divided. The difference between the height of the center of gravity 42 of the whole body and the height of the heart 41 is calculated, and then the load level on the circulatory system is estimated as a relative value with the height difference in a standing position as the reference (100%) as illustrated in FIG. 2. The model illustrated in FIG. 2 is a model equivalent to the 50th percentile of the Japanese, but this should not be construed as a limitation. See “Makiko Kouchi, Masaaki Mochimaru, Hiromu Iwasawa, and Seiji Mitani, 2000: Anthropometric database for Japanese Population 1997-98, Japanese Industrial Standards Center (AIST, MITI)” as needed for the “body dimension equivalent to the 50th percentile of the Japanese”. See “H. MATSUI, Determination of Center of Gravity of Human Body in Various Postures, Japanese Society of Physical Education 2(2): pp65-76, 1956” as needed for “masses and center-of-gravity positions of the segments of the body”. See “Toshio Ohashi: Atsu to sokudo no kankei (relationship between pressure and speed, hyojun seirigaku (Standard physiology), the sixth revision, pp562-563, IGAKU-SHOIN Ltd. (2005))” as needed for the “height of the heart”.

### (Shift in Load Level on Circulatory System at Wakefulness Induction)

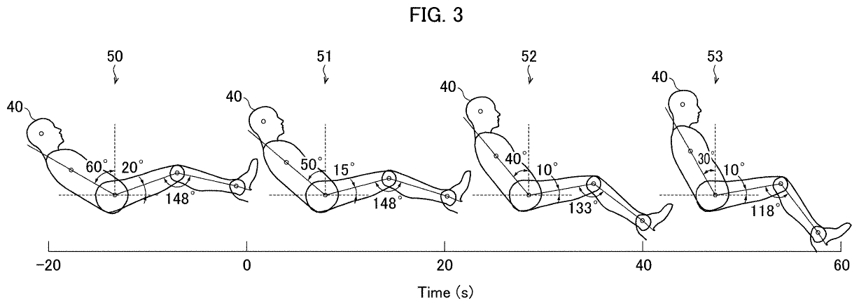

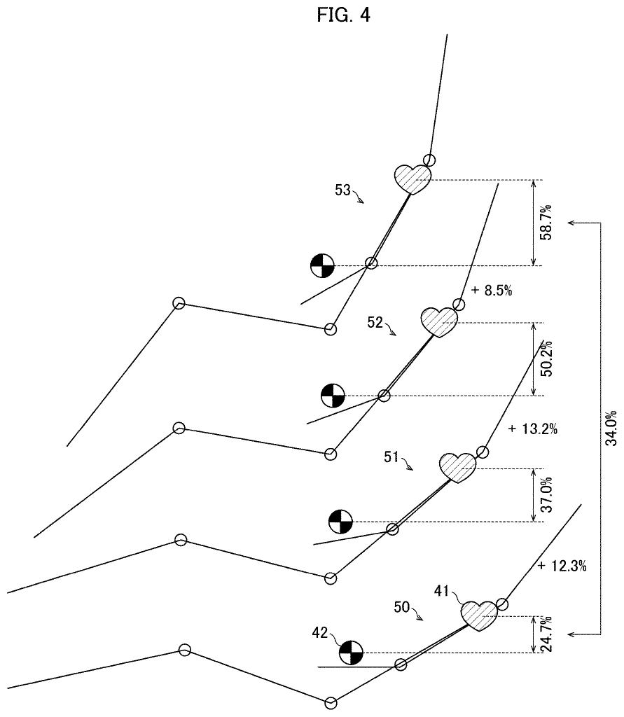

Now turning to FIGS. 3 and 4, the following description will discuss one example of a shift in a load level on the circulatory system in wakefulness induction. FIG. 3 illustrates one example of a position change in wakefulness induction. FIG. 4 illustrates a load level on the circulatory system in the position change illustrated in FIG. 3.

As illustrated in FIG. 3, the motor 21 is controlled to cause the wakefulness induction to start at the timing of 0 second and change the position of the user 40 at intervals of 20 seconds. Such a control is achieved by setting the time schedule to the controller 30.

At the timing of 0 second, the position of the user 40 changes from a position 50 to a position 51. The position 50, which is a sleeping position, corresponds to a semi-Fowler's position. The term “semi-Fowler's position” is defined as a position in which the upper body of a person has been raised by approximately 15° to 30° from a state in which the person lies with his/her face up. The following description will assume that the semi-Fowler's position is a position in which the upper body has been raised by 30°, as illustrated as the position 50 in FIG. 3. In the following description, the “position 50” may be referred to as “semi-Fowler's position 50”. In the semi-Fowler's position 50, the flexion angle of the thigh is 20° and the flexion angle of the knee joint is 148°.

Next, the position 51 will be described. The position 51 is a position in which the upper body has been further raised by 10° from the semi-Fowler's position 50. In the position 51, the bending angle of the thigh is 15°, and the bending angle of the knee joint is 148°, which is unchanged from the semi-Fowler's position 50.

When 20 seconds have passed since the position had become the position 51, the position of the user 40 is changed to a position 52. The position 52 is a position in which the upper body has been further raised by 10° from the position 51. In the position 52, the flexion angle of the thigh is 10° and the flexion angle of the knee joint is 133°.

When 20 seconds have passed since the position had become the position 52, the position of the user 40 is changed to a position 53. The position 53 is a position in which the upper body has been further raised by 10° from the position 52. In the position 53, the flexion angle of the thigh is 10°, which is unchanged from the position 52, and the flexion angle of the knee joint is 118°. The position 53 corresponds to the chair-seated position. The term “chair-seated position” refers to a position in which a person is seated on a chair, and the following description will assume that the chair-seated position is, as one example, a position in which the upper body has been raised by 60° from a state in which the person lies with his/her face up. In the following description, the “position 53” may be referred to as “chair-seated position 53”.

The angles of the body in the semi-Fowler's position 50, the position 51, the position 52, and the chair-seated position 53 which are illustrated in FIG. 3 are set so that the load level on the circulatory system is increased in stages by 8% to 15%. This will be described in detail with reference to FIG. 4. The inventors estimated the load level on the circulatory system in the semi-Fowler's position 50. The result of the estimation was 24.7%, as illustrated in FIG. 4. The inventors adjusted the angle of the body in the position 51 so that the load level on the circulatory system was increased by 8% to 15% when the position was changed from the semi-Fowler's position 50. In the example illustrated in FIG. 4, when the position is changed from the semi-Fowler's position 50 to the position 51, the load level on the circulatory system is increased by 12.3%. In other words, the angle of the body in the position 51 is adjusted so that the load level on the circulatory system in the position 51 becomes 37.0%.

Similarly, the inventors adjusted the angle of the body in the position 52 so that the load level on the circulatory system was increased by 8% to 15% when the position was changed from the position 51. In the example illustrated in FIG. 4, when the position is changed from the position 51 to the position 52, the load level on the circulatory system is increased by 13.2%. In other words, the angle of the body in the position 52 is adjusted so that the load level on the circulatory system in the position 52 becomes 50.2%.

Similarly, the inventors adjusted the angle of the body in the chair-seated position 53 so that the load level on the circulatory system was increased by 8% to 15% when the position was changed from the position 52. In the example illustrated in FIG. 4, when the position is changed from the position 52 to the chair-seated position 53, the load level on the circulatory system is increased by 8.5%. In other words, the angle of the body in the chair-seated position 53 is adjusted so that the load level on the circulatory system in the chair-seated position 53 becomes 58.7%.

The total of the amounts by which the load on the circulatory system has been increased in stages from the semi-Fowler's position 50 to the chair-seated position 53 via the position 51 and the position 52 is 34%. This value is lower than the value (50%) of the load level on the circulatory system at a tilt angle of 30° in the head-up tilt test. The detail will be described later.

### EXAMPLES

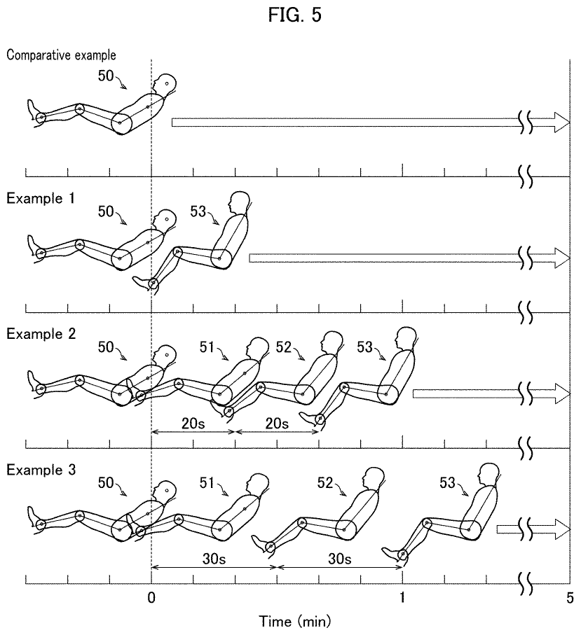

The inventors experimented on the effect of a position change in wakefulness induction on the heart rate. In the experiment, after a subject was kept still in the chair-seated position 53 for 5 minutes and then was kept still in the semi-Fowler's position 50 for 10 minutes, a change in heart rate by the wakefulness induction conducted for 5 minutes was observed. The number of the experimental samples was n=10. The wakefulness induction was conducted in the following four patterns: Comparative Example, Example 1, Example 2, and Example 3, as illustrated in FIG. 5.

In Comparative Example, the position remained the semi-Fowler's position 50, without any change. In Example 1, the position was changed by one movement from the semi-Fowler's position 50 to the chair-seated position 53. In Example 2, the position was changed by three movements from the semi-Fowler's position 50 to the chair-seated position 53 via the position 51 and the position 52 at intervals of 20 seconds. In Example 2, the position was changed as described in FIG. 3. In Example 3, the position was changed by three movements from the semi-Fowler's position 50 to the chair-seated position 53 via the position 51 and the position 52 at intervals of 30 seconds.

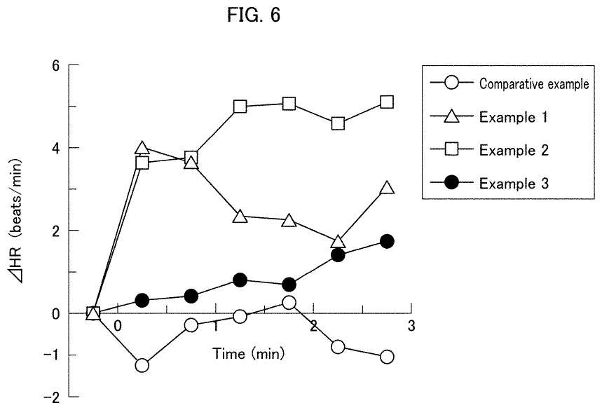

The inventors conducted a statistical process on heart rates at every 30 seconds between 0 second and 3 minutes with the start timing of the stimulus corresponding to the wakefulness induction being set to 0 second. FIG. 6 shows the result of the statistical processing. In FIG. 6, the horizontal axis shows time and the vertical axis shows an amount of the change in heart rate (HR: Heart Rate) per minute. As is clear from FIG. 6, it is found that all of Examples 1 to 3 exhibited more increase in heart rate than Comparative Example. Example 2 shows that when the position is changed from the semi-Fowler's position 50 to the chair-seated position 53, the heart rate is smoothly increased by approximately 5 beats.

(Comparison with Head-Up Tilt Test)

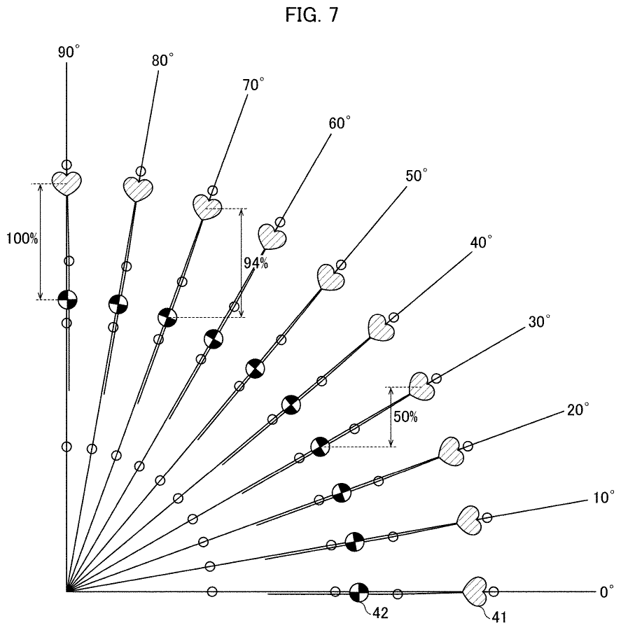

The inventors estimated the load level on the circulatory system based on the height difference between the center of gravity 42 of the whole body and the heart 41 in the head-up tilt test. FIG. 7 shows the result of the estimation. As a result of the estimation, as illustrated in FIG. 7, the load level on the circulatory system at a tilt angle of 70° which corresponds to the standing position was estimated to be 94.0%. The load level on the circulatory system at a tilt angle of 30° which corresponds to the chair-seated position was estimated to be 50.0%.

The above description explains that in the head-up tilt test, the heart rate is increased by approximately 5 to 8 beats per minute at a tilt angle of 30° which corresponds to the chair-seated position. In Example 2, as illustrated in FIG. 6, the heart rate was increased by approximately 5 beats per minute, achieving an increase in heart rate equivalent to that at a tilt angle of 30°. Further, in Example 2, when the position was changed from the semi-Fowler's position 50 to the chair-seated position 53, the load on the circulatory system was increased by 34.0% in total, which value is lower than the load level (50%) on the circulatory system at a tilt angle of 30°. That is, according to Example 2, an increase in heart rate equivalent to that at the tilt angle of 30° is achieved with a smaller load on the circulatory system than that at the tilt angle of 30°. Therefore, Example 2 allows for reduction in a load on the body when getting up, and for smoothly getting up.

In Example 2, as explained in FIG. 4, the load level on the circulatory system in the chair-seated position 53 is adjusted to be 58.7%, which value is higher than the load level (50%) on the circulatory system at a tilt angle of 30°. The adjustment such that the load level on the circulatory system in the chair-seated position 53 becomes not less than 50% as described above allows for reduction in a load on the circulatory system which is increased when the position transitions to the standing position and can achieve the smoothly getting up.

Note that it is not essential to increase the heart rate by approximately 5 to 8 beats per minute. As in Example 1 and Example 3, even if the increase in heart rate per minute is less than 5 to 8 beats, although the effect is low compared to Example 2, it is possible to reduce the load on the body when getting up.

### Effects

As described above, the get-up assistance device 100 in accordance with the present embodiment provides the following effects.

The get-up assistance device 100 includes: the body section 10 made up from the seat section 11 configured to support a thigh of the user 40, the upper-body support section 12 coupled to one end part of the seat section 11 and configured to support an upper body of the user 40, the lower-leg support section 13 coupled to another end part of the seat section 11 and configured to support a lower leg of the user 40; the driving mechanism 20 capable of changing a position of the user 40, the driving mechanism 20 being provided to the body section 10; and the controller 30 configured to control the driving mechanism 20. The controller 30 controls the position of the user 40 by driving the driving mechanism 20 so that the load level on the circulatory system based on the height difference between the center of gravity 42 of the whole body of the user 40 and the heart 41 of the user 40 becomes not less than a predetermined value with the load level on the circulatory system in the standing position as a reference.

According to the above configuration, controlling the position of the user 40 considering the load level on the circulatory system based on the height difference between the center of gravity 42 of the whole body and the heart 41 makes it possible to increase the heart rate while reducing the load on the body. This makes it possible to, for example, smoothly induce even who is suffering from orthostatic hypotension to get up.

The controller 30 may control the position of the user 40 by driving the driving mechanism 20 so that the load level on the circulatory system becomes not less than 50% with the load level on the circulatory system in the standing position as a reference.

According to the above configuration, controlling the position of the user 40 so that the load level on the circulatory system becomes not less than 50% with the standing position as a reference makes it possible to increase the heart rate while reducing the load on the body, thereby making it possible to induce smoothly getting up.

The controller 30 may control the position of the user 40 by driving the driving mechanism 20 so that the load level on the circulatory system is increased in stages by 8% to 15% at a predetermined time interval. The predetermined time interval may be 20 seconds as illustrated in Example 2, or may be 30 seconds as illustrated in Example 3, or may be 10 seconds. That is, the predetermined time interval may be any time interval ranging from 10 seconds to 30 seconds.

According to the above configuration, raising the upper body of the user 40 in stages at time intervals of 10 to 30 makes it possible to increase the heart rate while reducing a load on the body, thereby making it possible to smoothly induce the user 40 to get up.

The controller 30 may change the load level on the circulatory system at an irregular interval or change the position of the user 40 at a predetermined time interval.

According to the above configuration, the upper body of the user 40 is raised in stages, so that it is possible to increase the heart rate while reducing the load on the body, thereby making it possible to smoothly induce the user 40 to get up.

### OTHER EMBODIMENTS

The get-up assistance device 100 may further include a sensor configured to detect a heart rate of the user 40. In this case, the controller 30 may control an amount by which the load level on the circulatory system is increased in stages and the time interval at which the position is changed, in accordance with a change in the heart rate which has been detected by the sensor. For example, in a case where a change in heart rate is large, the controller 30 may reduce the amount by which the load level on the circulatory system is changed in stages and lengthen the time interval at which the position is changed, compared with the case where the change is small. In contrast, in a case where a change in heart rate is small, the controller 30 may increase the amount by which the load level on the circulatory system is changed in stages and shorten the time interval at which the position is changed, compared with the case where the change is large.

According to the above configuration, a position change and a get-up assistance that are suited to the user 40 are achieved by, considering a change in the heart rate of the user 40, controlling the amount by which the load level on the circulatory system is changed in stages and the time interval at which the position is changed.

The controller 30 may, before raising an upper body of the user 40, drive the upper-body support section 12 in a direction opposite to a direction in which to raise the upper body of the user 40.

According to the above configuration, the upper body of the user 40 is raised after the upper-body support section 12 is driven in the opposite direction, so that it is possible to make a larger driving angle. When the controller 30 drives the upper-body

support section 12 in the direction opposite to a direction in which to raise the upper body of the user 40, the controller 30 may drive the upper-body support section 12 in the opposite direction at a speed slower than that at which to raise the upper body of the user 40.

According to the above configuration, the driving of the upper-body support section 12 in the opposite direction at a speed slower than that at which to raise the upper body of the user 40 makes it possible to reduce uncomfortableness that the user 40 feels, while making a larger driving angle.

An estimation program used for estimating the load level on the circulatory system based on the height difference between the center of gravity 42 of the whole body and the heart 41 may cause a computer to carry out the following processes: (1) a process of calculating a center of gravity of each of segments of a body of the user 40; (2) a process of calculating the center of gravity 42 of the whole body of the user 40 on the basis of the center of gravity of each of the segments; (3) a process of calculating a height difference between the center of gravity 42 of the whole body and the heart 41 in a gravitational direction; and (4) a process of estimating a load level on a circulatory system as a relative value with the height difference in a standing position as a reference on the basis of the height difference.

According to the configuration, it is possible to estimate the load level on the circulatory system based on the height difference between the center of gravity 42 of the whole body and the heart 41.

The present disclosure is not limited to the embodiments above, but can be altered in various ways by a skilled person in the art within the scope of the claims. The present disclosure also encompasses, in its technical scope, any embodiment derived by combining technical means disclosed in differing embodiments as appropriate.

### REFERENCE SIGNS LIST

100 Get-up assistance device
10 Body section
11 Seat section
12 Upper-body support section
13 Lower-leg support section
20 Driving mechanism
30 Controller
41 Heart
42 Center of gravity of whole body

1. A get-up assistance device comprising:
a body section made up from a seat section configured to support a thigh of a user, an upper-body support section coupled to one end part of the seat section and configured to support an upper body of the user, and a lower-leg support section coupled to another end part of the seat section and configured to support a lower leg of the user;
a driving mechanism capable of changing a position of the user, the driving mechanism being provided to the body section; and
a controller configured to control the driving mechanism,
the controller controlling the position of the user by driving the driving mechanism so that a load level on a circulatory system based on a height difference between a center of gravity of a whole body of the user and a heart of the user becomes not less than a predetermined value with the load level on the circulatory system in a standing position as a reference.

2. The get-up assistance device according to claim 1, wherein the controller controls the position of the user by driving the driving mechanism so that the load level on the circulatory system becomes not less than 50% with the load level on the circulatory system in the standing position as a reference.

3. The get-up assistance device according to claim 2, wherein the controller controls the position of the user by driving the driving mechanism so that the load level on the circulatory system is increased in stages by 8% to 15% at a predetermined time interval.

4. The get-up assistance device according to claim 3, wherein the predetermined time interval is 10 seconds to 30 seconds.

5. The get-up assistance device according to claim 3, further comprising a sensor configured to detect a heart rate of the user,
the controller controlling an amount by which the load level on the circulatory system is changed in stages and the predetermined time interval, in accordance with a change in the heart rate which has been detected by the sensor.

6. The get-up assistance device according to claim 1, wherein the controller changes the load level on the circulatory system at an irregular interval or changes the position of the user at a predetermined time interval.

7. The get-up assistance device according to claim 1, wherein the controller, before raising the upper body of the user, drives the upper-body support section in a direction opposite to a direction in which to raise the upper body of the user.

8. The get-up assistance device according to claim 7, wherein when the controller drives the upper-body support section in the direction opposite to the direction in which to raise the upper body of the user, the controller drives the upper-body support section in the opposite direction at a speed slower than that at which to raise the upper body of the user.

9. A get-up assistance method used for a get-up assistance device including:
a body section made up from a seat section configured to support a thigh of a user, an upper-body support section coupled to one end part of the seat section and configured to support an upper body of the user, and a lower-leg support section coupled to another end part of the seat section and configured to support a lower leg of the user;
a driving mechanism capable of changing a position of the user, the driving mechanism being provided to the body section; and
a controller configured to control the driving mechanism,
the method comprising controlling the position of the user by driving the driving mechanism so that a load level on a circulatory system based on a height difference between a center of gravity of a whole body of the user and a heart of the user becomes not less than a predetermined value with the load level on the circulatory system in a standing position as a reference.

10. A computer-readable storage medium storing an estimation program that causes a computer to carry out:
a process of calculating a center of gravity of each of segments of a body of a user;
a process of calculating a center of gravity of a whole body of the user on the basis of the center of gravity of each of the segments;
a process of calculating difference between the center of gravity of the whole body and a heart in a gravitational direction; and
a process of estimating a load level on a circulatory system as a relative value with the height difference in a standing position as a reference on the basis of the height difference.
